(19) United States
(12) Patent Application Publication
(10) Pub. No.: US 2013/0321825 A1
(43) Pub. Date: Dec. 5, 2013

(54) LASER DISTANCE MEASURING DEVICE

(71) Applicant: Chervon (HK) Limited, Wanchai (HK)

(72) Inventors: Yangjian Xu, Nanjing (CN); Yunfeng Hu, Nanjing (CN)

(73) Assignee: Chervon (HK) Limited, Wanchai (HK)

(21) Appl. No.: 13/901,841

(22) Filed: May 24, 2013

(30) Foreign Application Priority Data
Jun. 4, 2012 (CN) 201210181051.X

(51) Int. Cl. G01B 11/14

(52) U.S. Cl. CPC G01B 11/14
USPC 356/614

(57) ABSTRACT

A laser distance measuring device includes a laser module, a receiving lens, and a photoelectric conversion device. The receiving lens includes a first curved surface and a second curved surface having a curvature different from that of the first curved surface. The second curved surface is used to converge part of reflected beams passing through the receiving lens onto a focal plane so as to form a continuous optical band and the continuous optical band gathers on the light receiving surface of the photoelectric conversion device.

### RELATED APPLICATION INFORMATION

This application claims the benefit of CN 201210181051.X, filed on Jun. 4, 2012, the disclosure of which is incorporated herein by reference in its entirety.

### BACKGROUND

The present disclosure relates to a laser distance measuring device, which belongs to the field of optical device.

The laser distance measuring device is used to perform an exact measurement for the distance of an objective by the laser. The basic structure of the laser distance measuring device includes a laser generating device, a collimating lens or lenses arranged on an emitting end of the laser generating device for transforming the laser emitted from the laser generating device into a collimated measuring beam and emitting the beam, a receiving lens for receiving the reflected measuring beams as reflected by the object to be measured and focusing the beams to form an image, a photoelectric conversion device arranged in the interior of the distance measuring device for receiving the image formed by the reflected measuring beams and converting an optical signal into a corresponding electric signal. The light receiving surface of the photoelectric conversion device is located on the focal plane of the receiving lens, and the electric signal is processed in order to obtain a distance measurement.

In the case where the object to be measured is at a large distance from the device, the optical path of the incident measuring beam is substantially parallel to that of the reflected measuring beams, therefore the reflected measuring beams may converge onto the receiving area of the optical signal receiving device after passing through the receiving lens. However, in the case where the object to be measured is at a small distance from the device, as shown in FIG. 1, the reflected measuring beams diffused by the object to be measured are inclined largely relative to the optical axis of the receiving lens, and converge onto a position away from the receiving area of the optical signal receiving device after passing through the receiving lens. Therefore, it is difficult to form an image on the receiving area of the optical signal receiving device, which causes the distance measurement to be more difficult.

The following are some existing means for solving the above problems: (1) providing an optical receiving device with an elongated shape for receiving the image formed by focusing the reflected beams from the measured object at a small distance—this means needs to make a special device and thereby has poor versatility and high cost; (2) providing two nested or separated secondary lenses on the receiving objective lens whereby, when measuring the distance, the reflected beams may form three light spots after being focused by the receiving objective lens, and when measuring a smaller distance, the three light spots may interconnect and exchange mutually so that the reflected beams reflected by the measured object at a small distance can be received by the optical signal receiving device. In this way, due to the two secondary lenses additionally arranged on the main receiving objective lens, a high manufacturing precision is required, and it is difficult to interconnect and exchange the three light spots exactly.

### SUMMARY

To overcome the shortcoming in the prior art, the following describes a laser distance measuring device, which can effectively solve the problem of receiving the reflected beams when the integrated laser distance measuring device is used to measure an object at a small distance. The reflected beams after being diffused by the measured object at a small distance are converged onto a continuous optical band on the focal plane by passing the reflected beams through a first curved surface and a second curved surface of the receiving lens.

More particularly, the subject laser distance measuring device, includes:

a laser module for generating a collimated measuring beam;

a receiving lens having a first curved surface for receiving reflected beams from an object to be measured and an optical axis parallel to an emitting optical axis of the measuring beam;

a photoelectric conversion device for photoelectrically converting an image formed by the reflected beams on a focal plane of the receiving objective lens, the photoelectric conversion device having a light receiving surface located on the focal plane of the receiving objective lens;

wherein the receiving lens further includes a second curved surface having a curvature different from that of the first curved surface, the second curved surface being used to converge part of the reflected beams passing through the receiving lens onto the focal plane so as to form a continuous optical band, and the continuous optical band gathers on the light receiving surface of the photoelectric conversion device.

The tangent slope of the second curved surface may vary linearly.

The tangent slope of the second curved surface may vary in a quadratic curve.

The second curved surface may have one of a cylindrical surface and a spherical surface.

The receiving lens may be configured to have a convex side and a flat side, and the second curved surface may be protruded from the flat side of the receiving objective lens.

The receiving lens may be configured to have a convex side and a flat side, and the second curved surface may be recessed from the flat side of the receiving objective lens.

The second curved surface may be treated with a coating.

As will become apparent from the description which follows, among other advantages the described device has the advantage of providing a laser distance measuring device the can receive dispersing beams caused by the measuring beam emitted to and dispersed from the object at a small distance and converge the dispersed beams to the light receiving surface of the photoelectric conversion device. Moreover, the described device has a simple structure and can be achieved easily. Yet further, the described device provides enhanced distance measuring ability, and especially enhances the measuring precision for the object to be measured at a small distance.

### BRIEF DESCRIPTION OF THE DRAWINGS

FIG. 1 is a schematic view showing the prior laser distance measuring device when measuring an object at a small distance;

FIG. 2 is a schematic view showing a laser distance measuring device constructed according to the description which follows when measuring an object at a small distance;

FIG. 3 is a schematic view showing the optical band of the laser distance measuring device when measuring the object at a small distance;

FIGS. 4a-4b are schematic views showing an exemplary second curved surface of the laser distance measuring device;

FIG. 5 is a schematic view showing a further exemplary second curved surface of the laser distance measuring device.

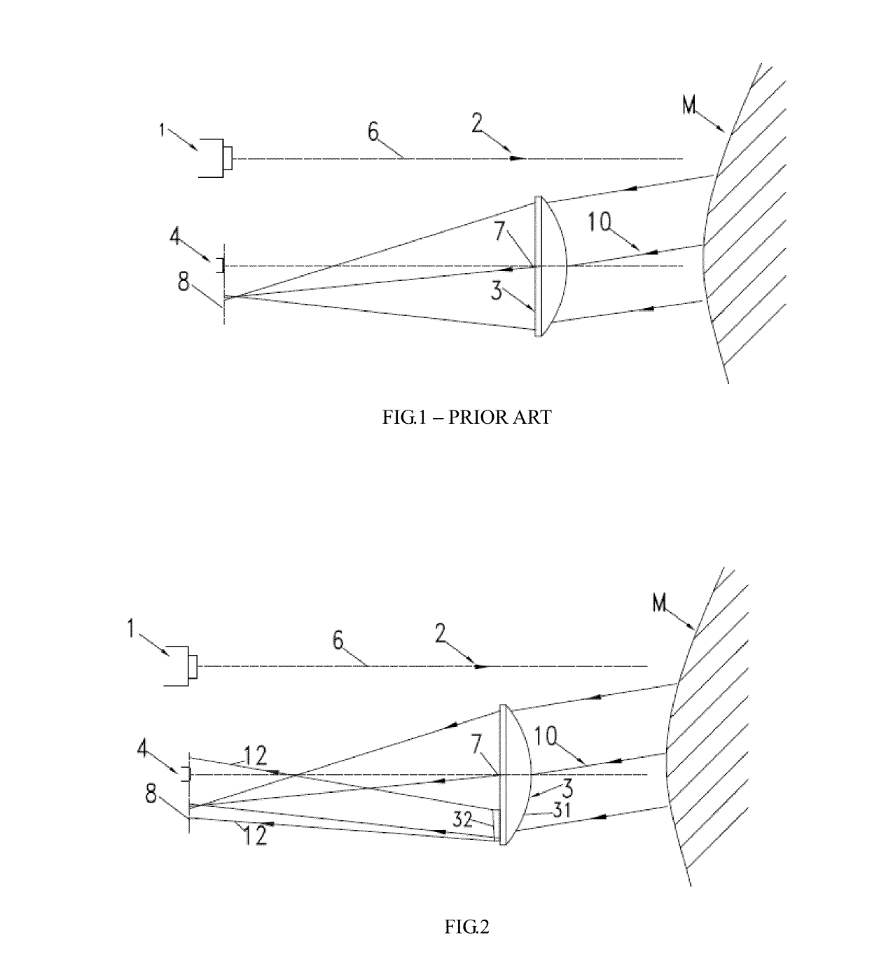

### DETAILED DESCRIPTION

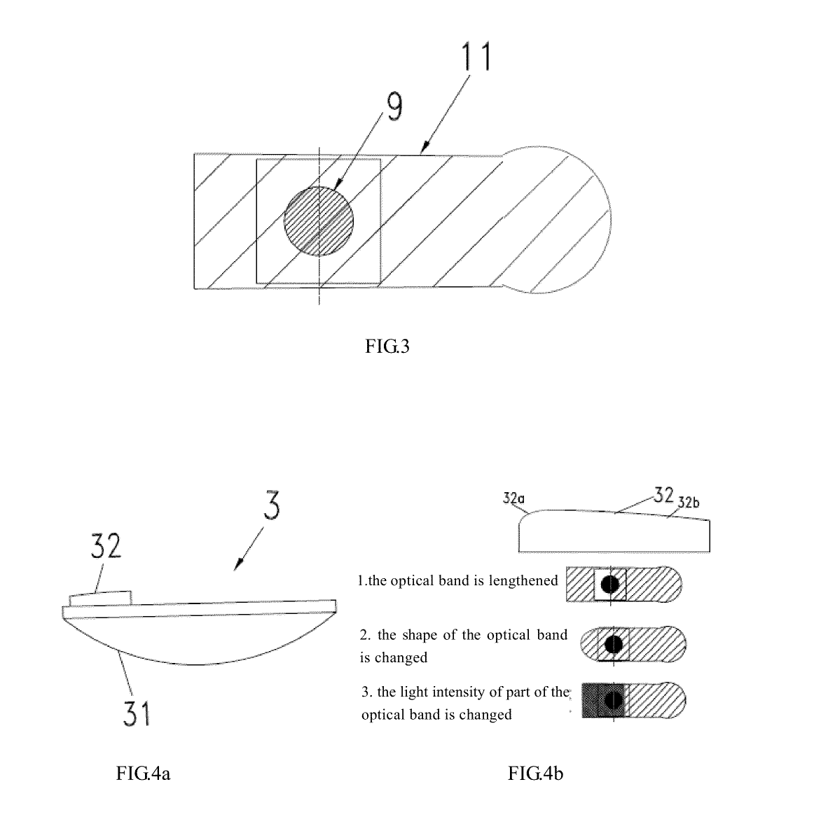

Referring to FIGS. 2 and 3, a preferred laser distance measuring device includes a laser module 1 for generating a collimated measuring beam 2 and emitting it to an object M to be measured; a receiving lens 3 having a first curved surface 31 for receiving reflected beams 10 from the measured object M; and a photoelectric conversion device 4 for photoelectrically converting the image formed by the reflected beams 10 on a focal plane 8 of the receiving objective lens. The receiving lens 3 has an optical axis 7 parallel to an emitting optical axis 6 of the measuring beam 2. The light receiving surface 9 of the photoelectric conversion device 4 is located on the focal plane 8 of the receiving lens. The receiving lens 3 also has a second curved surface 32 having a curvature different form that of the first curved surface 31. The second curved surface 32 is used to converge part of the reflected beams passing through the receiving lens 3 onto the focal plane 8 so as to form a continuous optical band 11, and the continuous optical band 11 gathers on the light receiving surface 9 of the photoelectric conversion device 4. That is to say, the reflected beams 10 reflected by the measured object can enter into the first curved surface 31 of the receiving objective lens 3 and then be refracted to partly pass through the second curved surface 32, and then converge to a continuous optical band 11 with a specific size and light intensity. The continuous optical band 11 is converged onto the light receiving surface 9 of the photoelectric conversion device 4.

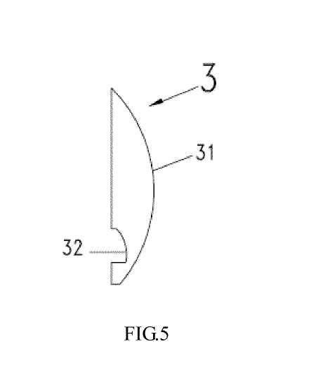

In an exemplary embodiment, the tangent slope of the second curved surface 32 varies linearly, for example, it is a continuous section of an arc surface, as shown in FIG. 4a. In another embodiment, the tangent slope of the second curved surface 32 varies in a quadratic curve. As shown in FIG. 4b, a first section 32a and/or a second section 32b of the second curved surface 32 may be changed to obtain different continuous bands 11 with different shapes and light intensities.

In some embodiments, the receiving lens 3 is configured to have a convex side and a flat side. The first curved surface 31 is formed on the convex side and the second curved surface 32 is formed on the flat side. In a preferable embodiment, the second curved surface 32 may be protruded from the flat side of the receiving objective lens 3, as shown in FIG. 2, and the second curved surface 32 may also be recessed from the flat side of the receiving objective lens 3, as shown in FIG. 5.

In some embodiments, the second curved surface 32 is configured as a cylindrical surface. In other embodiments, the second curved surface 32 is configured as a spherical surface. It will also be understood that the second curved surface 32 may be any curved surface which can vary linearly and form a continuous optical band 11 on the focal plane 8.

In some embodiments, the surface of the second curved surface 32 may be treated with a coating in order to reduce the effect of disturbing light on the distance measurement.

When the laser distance measuring device is used to perform a distance measurement for an object to be measured at a large distance from the device, the measuring beam generated by the laser module 1 is emitted to the object M to be measured and forms reflected beams 10 generally parallel to the incident optical axis 6 of the measuring beam after being diffused by the measured object M. The reflected beams 10 can be focused by the receiving lens 3 and converged onto the light receiving surface 9 (the optical signal receiving area) of the photoelectric conversion device 4 located on the focal plane 8. The photoelectric conversion device 4 converts the received optical signal to an electric signal, and then the electric signal is processed by a processor (not shown) so as to obtain a measured distance. At that moment, the photoelectric conversion device 4 has received the beams projected by the receiving objective lens 3 and the measured distance may be achieved based on the image formed by the projected beams.

When the laser distance measuring device is used to perform a distance measurement for an object to be measured at a small or ultra small distance from the device, the measuring beam 2 generated by the laser module 1 is emitted to the object M to be measured. Since the distance between the measured object M and the receiving objective lens 3 is relatively small, the reflected beams 10 will be diffused by the measured object M at an angle relative to the optical axis 7 of the receiving lens 3, that is to say, the reflected beams 10 are emitted into the receiving lens 3 obliquely. As shown in FIG. 2, after being focused by the first curved surface, the reflected beams 10 are partly emitted into the second curved surface 32. The second curved surface 32 will converge the reflected beams 10 which are partly emitted there into to form the continuous optical band 11. FIGS. 2-3 schematically shows the continuous optical band 11 formed by the projected beams 12 after being converged by the second curved surface 32, respectively. The continuous band 11 can still cover the light receiving surface 9 (the optical signal receiving area) of the photoelectric conversion device 4, thus the measured distance may be calculated.

The present invention is not to be limited to the above-described embodiments. Rather, all technical solutions obtainable by equivalent replacements or equivalent modifications are to be contained in the protection scope of the present invention.

What is claimed is:

1. A laser distance measuring device, comprising:
a laser module for generating a collimated measuring beam;
a receiving lens having a first curved surface for receiving reflected beams from an object to be measured and an optical axis parallel to an emitting optical axis of the measuring beam;
a photoelectric conversion device for photoelectrically converting an image formed by the reflected beams on a focal plane of the receiving lens, the photoelectric conversion device having a light receiving surface located on the focal plane of the receiving lens;
wherein the receiving lens further includes a second curved surface having a curvature different from that of the first curved surface, the second curved surface being used to converge part of the reflected beams passing through the receiving lens onto the focal plane so as to form a continuous optical band and wherein the continuous optical band gathers on the light receiving surface of the photoelectric conversion device.

2. The laser distance measuring device according to claim 1, wherein a tangent slope of the second curved surface varies linearly.

3. The laser distance measuring device according to claim 1, wherein a tangent slope of the second curved surface varies in a quadratic curve.

4. The laser distance measuring device according to claim 1, wherein the second curved surface is one of a cylindrical surface and a spherical surface.

5. The laser distance measuring device according to claim 1, wherein the receiving lens is configured to have a convex side and a flat side, and the second curved surface is protruded from the flat side of the receiving lens.

6. The laser distance measuring device according to claim 1, wherein the receiving lens is configured to have a convex side and a flat side, and the second curved surface is recessed from the flat side of the receiving lens.

7. The laser distance measuring device according to claim 1, wherein the photoelectric conversion device receives the beams converged by the second curved surface.

8. The laser distance measuring device according to claim 1, wherein the second curved surface is treated with a coating.
